(19) United States
(12) Patent Application Publication
(10) Pub. No.: US 2022/0177348 A1
(43) Pub. Date: Jun. 9, 2022

(54) SHAPED ARTICLES, METHODS AND APPARATUS FOR FORMING THE SAME, AND LIQUID LENSES COMPRISING THE SAME

(71) Applicant: CORNING INCORPORATED, CORNING, NY (US)

(72) Inventors: Thierry Luc Alain Dannoux, Avon (FR); Ronan Tanguy, Grez Sur Loing (FR)

(21) Appl. No.: 17/602,223

(22) PCT Filed: Apr. 2, 2020
(86) PCT No.: PCT/US2020/026333

§ 371 Date: Oct. 7, 2021

Related U.S. Application Data
(60) Provisional application No. 62/831,427, filed on Apr. 9, 2019.

(51) Int. Cl. C03B 40/00; C03B 23/00; G02B 3/12; B23C 3/34

(52) U.S. Cl. CPC C03B 40/00; C03B 23/0013; B23C 2220/56; B23C 3/34; G02B 3/12

(57) ABSTRACT

A shaped article can include a substrate formed from a glass material, a glass ceramic material, or a combination thereof and a cavity formed in the substrate. A sidewall of the cavity can have a random textured surface with a surface roughness of less than or equal to 300 nm. A method of machining a protrusion in a graphite block can include translating a cutting tool in a first longitudinal direction toward the graphite block to engage the graphite block with the cutting tool while rotating the cutting tool about a rotational axis without translating the cutting tool in a lateral direction, then translating the cutting tool in a second longitudinal direction away from the graphite block without translating the cutting tool in the lateral direction to disengage the cutting tool from the graphite block. A shaped article can be formed by pressing a preform with a monolithic graphite mold.

### CROSS-REFERENCE TO RELATED APPLICATIONS

This application claims the benefit of priority under 35 U.S.C. § 119 of U.S. Provisional Application No. 62/831,427, filed Apr. 9, 2019, the content of which is incorporated herein by reference in its entirety.

### BACKGROUND

### 1. Field

This disclosure relates to shaped articles and methods and apparatus for forming shaped articles, and more particularly to shaped glass articles and methods and apparatus for pressing glass preforms to form shaped glass articles, as well as liquid lenses comprising shaped articles.

### 2. Technical Background

Isothermal glass pressing generally includes pressing a glass plate at a relatively low temperature (e.g., a temperature at which the glass has a relatively high viscosity of 10¹⁰ poise to 10¹² poise) using a polished ceramic or metallic mold. Such high viscosity of the glass helps to prevent the glass from sticking to the mold and to maintain the surface quality of the finished article. The mold complexity and relatively high pressing force generally limits isothermal glass pressing to small glass articles with simple geometries (e.g., ophthalmic lenses).

### SUMMARY

Disclosed herein are shaped articles, methods and apparatus for forming shaped articles, and liquid lenses comprising shaped articles.

Disclosed herein is a shaped article comprising a substrate comprising a glass material, a glass-ceramic material, or a combination thereof and a cavity formed in the substrate, wherein a sidewall of the cavity comprises a random textured surface with a surface roughness of less than or equal to 300 nm.

Disclosed herein is a method of machining a protrusion in a graphite block comprising positioning a cutting tool adjacent the graphite block such that a rotational axis of the cutting tool is longitudinally aligned with an intended protrusion position on the graphite block. The protrusion can be formed in the graphite block by translating the cutting tool in a first longitudinal direction toward the graphite block to engage the graphite block with the cutting tool while rotating the cutting tool about the rotational axis and without translating the cutting tool in a lateral direction. The cutting tool can be translated in a second longitudinal direction away from the graphite block and without translating the cutting tool in the lateral direction to disengage the cutting tool from the graphite block.

Disclosed herein is a method of forming a shaped article comprising pressing a preform with a monolithic graphite mold comprising a mold body and a plurality of mold protrusions extending from the mold body at a pressing temperature and a pressing pressure sufficient to transform the preform into the shaped article comprising a plurality of cavities corresponding to the plurality of mold protrusions. The preform can comprise a glass material, a glass-ceramic material, or a combination thereof. The mold protrusions of the monolithic graphite mold can comprise a random textured surface.

Disclosed herein is an apparatus for pressing a plurality of cavities in a preform comprising a monolithic graphite mold comprising a mold body and a plurality of mold protrusions extending from the mold body. The mold protrusions of the monolithic graphite mold can comprise a random textured surface.

Disclosed herein is a liquid lens comprising a lens body comprising a first window, a second window, and a cavity disposed between the first window and the second window, and a first liquid and a second liquid disposed within the cavity of the lens body, the first liquid and the second liquid having different refractive indices such that an interface between the first liquid and the second liquid forms a lens. A sidewall of the cavity can comprise a random textured surface with a surface roughness of less than or equal to 300 nm.

It is to be understood that both the foregoing general description and the following detailed description are merely exemplary, and are intended to provide an overview or framework to understanding the nature and character of the claimed subject matter. The accompanying drawings are included to provide a further understanding and are incorporated in and constitute a part of this specification. The drawings illustrate one or more embodiment(s), and together with the description, serve to explain principles and operation of the various embodiments.

### BRIEF DESCRIPTION OF THE DRAWINGS

FIG. 1 is a perspective view of some embodiments of a mold of an apparatus that can be used to press a plurality of cavities in a preform to form a shaped article.

FIG. 2 is a close-up view of a portion of the mold shown in FIG. 1.

FIG. 3 is a schematic cross-sectional view of the portion of the mold shown in FIG. 2.

FIG. 4 is a schematic cross-sectional view of a portion of some embodiments of an apparatus comprising the mold shown in FIG. 1 and a backing plate.

FIG. 5 is a flowchart representing some embodiments of a method for forming a mold.

FIG. 6 is a schematic cross-sectional view of some embodiments of a cutting tool positioned adjacent a substrate.

FIG. 7 is a perspective view of some embodiments of a cutting tool.

FIG. 8 is a cross-sectional projection of the cutting tool shown in FIG. 7 during rotation of the cutting tool about a rotational axis.

FIG. 9 is a perspective view of some embodiments of a cutting tool engaged with a substrate to form a protrusion and an annular recess in the substrate.

FIG. 10 is a flowchart representing some embodiments of a method for forming a shaped article.

FIG. 11 is a perspective view of some embodiments of a preform.

FIG. 12 is a cross-sectional view of the preform shown in FIG. 11.

FIG. 13 is a cross-sectional schematic view of some embodiments of a method and apparatus for pressing.

FIG. 14 is a partial cross-sectional schematic view of some embodiments of a shaped article following pressing.

FIG. 15 is a cross-sectional schematic view of some embodiments of a shaped article following polishing.

FIG. 16 is a perspective view of some embodiments of a shaped sub-article formed by breaking a shaped article along a plurality of cutting paths.

FIG. 17 is a cross-sectional schematic view of some embodiments of a liquid lens incorporating a shaped article.

FIG. 18 is a flowchart representing some embodiments of a method for manufacturing a liquid lens.

### DETAILED DESCRIPTION

Reference will now be made in detail to exemplary embodiments which are illustrated in the accompanying drawings. Whenever possible, the same reference numerals will be used throughout the drawings to refer to the same or like parts. The components in the drawings are not necessarily to scale, emphasis instead being placed upon illustrating the principles of the exemplary embodiments.

Numerical values, including endpoints of ranges, can be expressed herein as approximations preceded by the term “about,” “approximately,” or the like. In such cases, other embodiments include the particular numerical values. Regardless of whether a numerical value is expressed as an approximation, two embodiments are included in this disclosure: one expressed as an approximation, and another not expressed as an approximation. It will be further understood that an endpoint of each range is significant both in relation to another endpoint, and independently of another endpoint.

As used herein, the term “average coefficient of thermal expansion,” or “average CTE,” refers to the average coefficient of linear thermal expansion of a given material between 0° C. and 300° C. As used herein, the term “coefficient of thermal expansion,” or “CTE,” refers to the average coefficient of thermal expansion unless otherwise indicated. The CTE can be determined, for example, using the procedure described in ASTM E228 “Standard Test Method for Linear Thermal Expansion of Solid Materials With a Push-Rod Dilatometer”, or for glass materials, ISO 7991:1987 “Glass—Determination of coefficient of mean linear thermal expansion.”

As used herein, the term “surface roughness” means Ra surface roughness determined as described in ISO 25178, Geometric Product Specifications (GPS)—Surface texture: areal, filtered at 25 μm.

As used herein, the term “non-stick,” when used in reference to a material from which a mold surface is formed, can mean that there is no substantial formation of an oxide layer at the interface between a substrate or preform material (e.g., a glass material, a glass-ceramic material, or a combination thereof) with the mold surface at a temperature at which the substrate material has a viscosity of 10⁸ poise. Additionally, or alternatively, the term “non-stick,” when used in reference to a material from which a mold surface is formed, can mean that the diffusion of any component of a substrate or preform material from the interface between the substrate material with the mold surface into the mold surface at a temperature at which the substrate material has a viscosity of 10⁸ poise is limited to a depth of 1 nm.

As used herein, the term “formed from” can mean one or more of comprises, consists essentially of, or consists of. For example, a component that is formed from a particular material can comprise the particular material, consist essentially of the particular material, or consist of the particular material.

In various embodiments, a shaped article comprises a substrate comprising a glass material, a glass-ceramic material, or a combination thereof and a cavity formed in the substrate, wherein a sidewall of the cavity comprises a random textured surface with a surface roughness of less than or equal to 300 nm. The surface topography of the random textured surface can be enabled by the mold and/or pressing process described herein.

In various embodiments, a method of machining a protrusion in a graphite block comprises positioning a cutting tool adjacent the graphite block such that a rotational axis of the cutting tool is longitudinally aligned with an intended protrusion position on the graphite block. The protrusion can be formed in the graphite block by translating the cutting tool in a first longitudinal direction toward the graphite block to engage the graphite block with the cutting tool while rotating the cutting tool about the rotational axis and without translating the cutting tool in a lateral direction. The cutting tool can be translated in a second longitudinal direction away from the graphite block and without translating the cutting tool in the lateral direction to disengage the cutting tool from the graphite block. Such longitudinal translation of the cutting tool without lateral translation during the machining can enable the smooth and/or straight sidewalls of the machined protrusion as described herein.

In various embodiments, a method of forming a shaped article comprises pressing a preform with a monolithic graphite mold comprising a mold body and a plurality of mold protrusions extending from the mold body at a pressing temperature and a pressing pressure sufficient to transform the preform into the shaped article comprising a plurality of cavities corresponding to the plurality of mold protrusions. The preform can comprise a glass material, a glass-ceramic material, or a combination thereof. The mold protrusions of the monolithic graphite mold can comprise a random textured surface. The random textured surface of the mold protrusions can be enabled by the machining process described herein. Additionally, or alternatively, the surface topography of the cavity sidewalls of the shaped article can be enabled by the random textured surface of the mold protrusions as described herein.

In various embodiments, an apparatus for pressing a plurality of cavities in a preform comprises a monolithic graphite mold comprising a mold body and a plurality of mold protrusions extending from the mold body. The mold protrusions of the monolithic graphite mold can comprise a random textured surface. The random textured surface of the mold protrusions can be enabled by the machining process described herein.

In various embodiments, a liquid lens comprises a lens body comprising a first window, a second window, and a cavity disposed between the first window and the second window, and a first liquid and a second liquid disposed within the cavity of the lens body, the first liquid and the second liquid having different refractive indices such that an interface between the first liquid and the second liquid forms a lens. A sidewall of the cavity can comprise a random textured surface with a surface roughness of less than or equal to 300 nm. The surface topography of the random textured surface can be enabled by the mold and/or pressing process described herein.

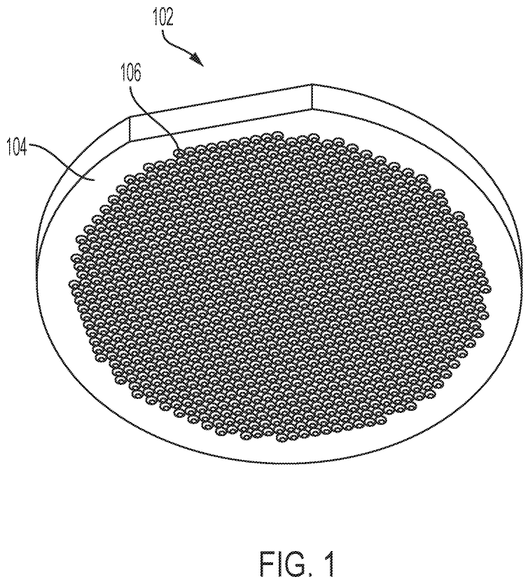

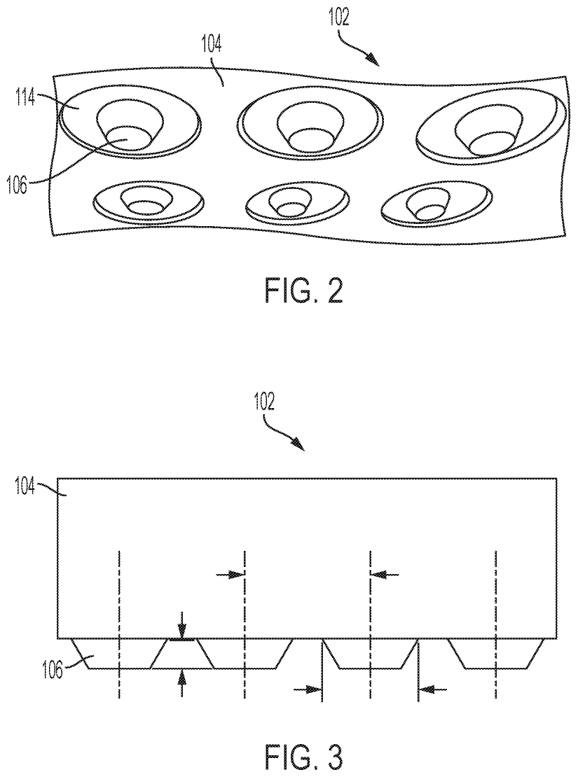

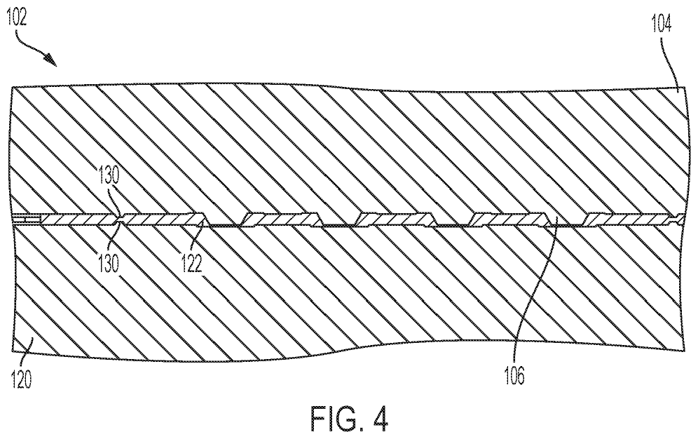

FIG. 1 is a perspective view of some embodiments of a mold 102 of an apparatus 100 that can be used to press a plurality of cavities in a preform to form a shaped article as described herein. FIG. 2 is a close-up view of a portion of mold 102, and FIG. 3 is a schematic cross-sectional view of the portion of the mold. FIG. 4 is a schematic cross-sectional view of a portion of apparatus 100 comprising mold 102 and a backing plate 120.

In some embodiments, apparatus 100 comprises mold 102. For example, mold 102 comprises a mold body 104 and a plurality of mold protrusions 106 extending from the mold body as shown in FIGS. 1-4. Mold body 104 and mold protrusions 106 can cooperatively define a mold surface to be engaged with a preform during pressing as described herein. In some embodiments, mold 102 comprises a monolithic mold. For example, mold body 104 and protrusions 106 can be formed from a single mass or body (e.g., a block) of mold material such that the mold body and the protrusions cooperatively define the monolithic mold. In some embodiments, protrusions 106 can be machined in a substrate (e.g., a graphite block) as described herein to form the monolithic mold.

In some embodiments, mold 102 (e.g., mold body 104 and/or mold protrusions 106) is formed from a non-stick and/or porous material. For example, mold 102 is formed from a graphite material. The graphite material can have properties (e.g., porosity, grain size, coefficient of thermal expansion (CTE), etc.) that enable mold 102 having beneficial characteristics for use for pressing as described herein. Potentially suitable graphite materials can include, for example, EDM 4 or AF 5 grades commercially available from Poco Graphite, Inc. (Decatur, Tex., USA).

In some embodiments, the graphite material has an open porosity of greater than 0%. For example, the graphite material has an open porosity of about 0.1%, about 0.2%, about 0.3%, about 0.4%, about 0.5%, about 0.6%, about 0.7%, about 0.8%, about 0.9%, about 1%, about 1.5%, about 2%, about 2.5%, about 3%, about 3.5%, about 4%, about 4.5%, about 5%, about 6%, about 7%, about 8%, about 9%, about 10%, or any ranges defined by the listed values. The porosity (e.g., open and/or closed porosity) of graphite materials can be determined, for example, using mercury porosimetry. For example, mercury porosimetry measurements can be made using a mercury porosimeter (e.g., Model 915-2) commercially available from Micromeritics Instrument Corp. (Norcross, Ga., USA). The porosity can be determined, for example, using the procedure described in ASTM C709—Standard Terminology Relating to Manufactured Carbon and Graphite. The open porosity of the graphite material can help to reduce the impact of outgassing from the preform during pressing and/or enable the mold to be separated from the shaped article after pressing as described herein.

In some embodiments, the graphite material has a grain size of about 1 μm, about 2 μm, about 3 μm, about 4 μm, about 5 μm, or any ranges defined by the listed values. For example, the graphite material can be a fine grain graphite material with a relatively small grain size or average particle size. The grain size of the graphite material can be measured, for example, by scanning electron micrography (SEM), and can be reported by a manufacturer of the graphite material (e.g., based on analysis of the raw materials used to form the graphite material). The grain size of the graphite material can help to enable the mold having a low surface roughness, thereby enabling a shaped article with a corresponding low surface roughness as described herein.

In some embodiments, the graphite material has a CTE that is compatible with the preform during pressing as described herein. For example, the graphite material has a CTE within about 8×10⁻⁷/° C., within about 7×10⁻⁷/° C., within about 6×10⁻⁷/° C., within about 5×10⁻⁷/° C., within about 4×10⁻⁷/° C., within about 3×10⁻⁷/° C., within about 2×10⁻⁷/° C. of a CTE of the preform, or any ranges defined by the listed values. In some embodiments, the CTE of the graphite material is less than the CTE of the preform. In some embodiments, the CTE of the graphite material is greater than the CTE of the preform. In some embodiments, a difference between the CTE of the graphite material and the CTE of the preform is at least about 1×10⁻⁷/° C. In some embodiments, the graphite material has a CTE of about 25×10⁻⁷/° C., about 30×10⁻⁷/° C., about 35×10⁻⁷/° C., about 40×10⁻⁷/° C., about 45×10⁻⁷/° C., about 50×10⁻⁷/° C., about 55×10⁻⁷/° C., about 60×10⁻⁷/° C., about 65×10⁻⁷/° C., about 70×10⁻⁷/° C., about 75×10⁻⁷/° C., about 80×10⁻⁷/° C., about 85×10⁻⁷/° C., about 90×10⁻⁷/° C., or any ranges defined by the listed values. The graphite material with a CTE that is close to the CTE of the preform can help to prevent breakage of the preform during pressing and/or to maintain accurate positioning of the cavities formed in the preform during pressing as described herein. Additionally, or alternatively, the graphite material with a CTE that differs sufficiently from the CTE of the preform can help to enable the mold to be separated from the preform (e.g., demolding) during pressing as described herein.

Forming mold 102 from the porous material (e.g., the graphite material) can enable the mold to have a large mold surface. For example, in some embodiments, the mold surface has an area (e.g., an area defined within a perimeter of the mold surface) of about 100 cm², about 200 cm², about 300 cm², about 400 cm², about 500 cm², about 750 cm², about 1000 cm², or any ranges defined by the listed values. Such a large mold surface can be difficult to manufacture using non-porous materials, which can be difficult to machine using conventional diamond tooling. Forming mold protrusions 106 using the forming process described herein can enable the mold protrusions having low surface roughness even though the mold protrusions are formed from the porous material, which typically yield machined surfaces with higher than desirable surface roughness (e.g., greater than 200 nm).

In some embodiments, mold protrusions 106 are configured as pins projecting from mold body 104. Additionally, or alternatively, mold protrusions 106 are configured to engage a preform to form a plurality of cavities corresponding to the mold protrusions as described herein. For example, mold protrusions 106, or a portion thereof, are sized and shaped to form cavities in the preform having a desired size and shape. In some embodiments, mold protrusion 106 comprises an engaging member extending away from mold body 104. In some embodiments, a size of mold protrusion 106 corresponds to a desired size of the cavities to be formed in the preform upon pressing. For example, mold protrusion 106 can have a diameter or width of about 5 mm, about 4 mm, about 3 mm, about 2 mm, about 1 mm, about 0.5 mm, or any ranges defined by the listed values. The diameter or width of mold protrusion 106 can refer to the diameter or width at a proximal end of the mold protrusion (e.g., closest to mold body 104) and/or a distal end of the mold protrusion (e.g., farthest from the mold body). Such a small mold protrusion and the resulting small cavities with smooth and/or straight sidewalls formed in the preform can be enabled by the methods and apparatus described herein. In some embodiments, mold protrusion 106 has a shape corresponding to a desired shape of the cavities to be formed in the preform upon pressing. For example, in the embodiments shown in FIGS. 1-4, mold protrusion 106 has a tapered or truncated conical (e.g., frustoconical) shape. Thus, mold protrusion 106 comprises a tapered pin. In other embodiments, the engaging portion of the mold protrusion can have a cylindrical, rounded, or other suitable shape. In various embodiments, mold protrusion 106 has an axisymmetric (e.g., rotationally symmetrical) shape about a longitudinal axis of the mold protrusion.

In some embodiments, a number of mold protrusions in the plurality of mold protrusions corresponds to a desired number of cavities in the plurality of cavities of a shaped article as described herein. For example, the number of mold protrusions 106 in the plurality of mold protrusions can be about 10, about 50, about 100, about 200, about 300, about 400, about 500, about 600, about 700, about 800, about 900, about 1000, about 1100, about 1200, about 1300, about 1400, about 1500, about 2000, or any ranges defined by the listed values. The large number of mold protrusions in the plurality of mold protrusions can be enabled by the low surface roughness of the engaging portions of the mold protrusions. For example, the low surface roughness can enable pressing a glass preform to form a shaped glass article with cavities having low surface roughness as described herein.

In some embodiments, mold protrusion 106 has a surface roughness of about 400 nm, about 300 nm, about 200 nm, about 150 nm, about 100 nm, about 50 nm, about 40 nm, about 30 nm, about 20 nm, or any ranges defined by the listed values. Such a smooth engaging surface can be enabled by machining the mold protrusion as described herein. Additionally, or alternatively, such a smooth engaging surface can enable formation of cavities with smooth sidewalls, which may be beneficial for applications such as liquid lenses as described herein.

In some embodiments, mold body 104 comprises an annular recess 114 surrounding each of the plurality of mold protrusions 106 as shown in FIG. 2. For example, annular recess 114 is an indentation or depression in a surface of mold body 104 that partially or entirely encircles mold protrusion 106. In some embodiments, annular recess 114 has a shape that is substantially the same as the shape of mold protrusion 106. For example, in the embodiments shown in FIG. 3, annular recess 114 has a circular shape corresponding to the circular cross-sectional shape of mold protrusion 106. In other embodiments, the annular recess and the mold protrusion can have different shapes. Annular recess 114 can serve as a void into which preform material can flow during pressing as described herein, which can reduce the pressing force used to press the preform.

In some embodiments, apparatus 100 comprises a backing plate 120 as shown in FIG. 4. During pressing, the preform can be pressed between the mold and the backing plate as described herein. In some embodiments, backing plate 120 comprises a plurality of depressions 122 corresponding to the plurality of mold protrusions 106 of mold 102. For example, depression 122 is an indentation or recess in a surface of backing plate 120 that is at least partially aligned with a corresponding mold protrusion 106. In some embodiments, depression 122 has a shape that is substantially the same as the cross-sectional shape of mold protrusion 106. For example, in the embodiments shown in FIG. 4, depression 122 has a circular shape corresponding to the circular cross-sectional shape of mold protrusion 106. In other embodiments, the depression and the mold protrusion can have different shapes. Depressions 122 can serve as voids into which preform material can flow during pressing as described herein, which can reduce the degree to which the preform sticks to mold 102 and/or reduce the pressing force used to press the preform.

In some embodiments, backing plate 120 is formed from a porous material as described herein with reference to mold 102 (e.g., mold body 104 and/or mold protrusions 106). Backing plate 120 and mold 102 can be formed from the same or different materials.

In some embodiments, apparatus 100 comprises one or more ribs 130 disposed on the engaging surface of mold 102 (e.g., mold body 104) and/or backing plate 120. For example, in the embodiments shown in FIG. 4, mold body 104 comprises one or more ribs 130 disposed on the engaging surface of the mold body, and backing plate 120 comprises one or more corresponding ribs 130 disposed on the engaging surface of the backing plate. The ribs can form thinned segments in the preform during pressing as described herein to enable separation of the shaped article following the pressing. For example, the thinned segments can be configured as breaking lines along which the shaped article can be mechanically broken (e.g., by bending).

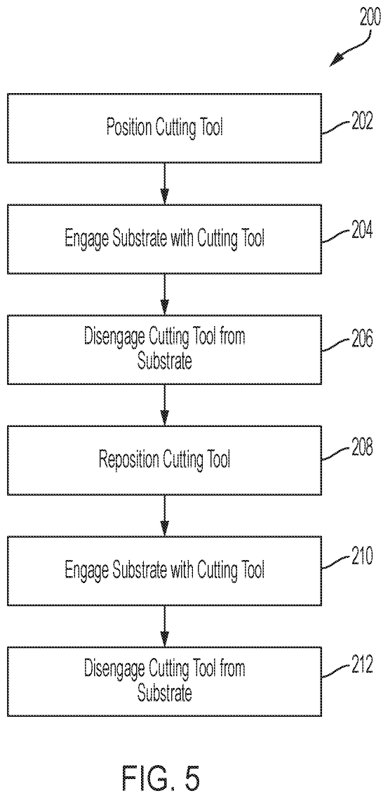

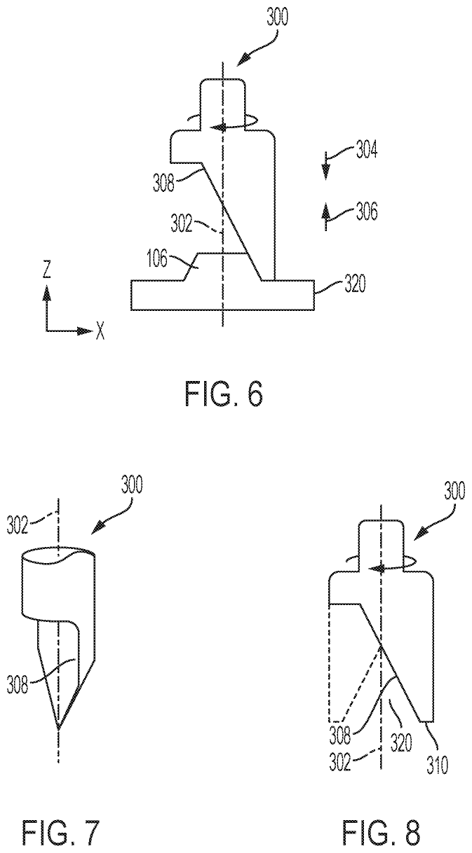

FIG. 5 is a flowchart representing some embodiments of a method 200 for forming a mold (e.g., mold 102). For example, the method comprises machining a protrusion in a substrate. In some embodiments, the substrate comprises a graphite block, which can enable forming mold 102 (e.g., a monolithic mold) as described herein. In some embodiments, a cutting tool is positioned adjacent the substrate at step 202. FIG. 6 is a schematic cross-sectional view of a cutting tool 300 positioned adjacent a substrate 320. It should be noted that substrate 320 shown in FIG. 6 has already been machined as described herein to form a machined surface comprising protrusion 106. Prior to machining, substrate 320 can be substantially planar (e.g., having substantially planar outer surfaces). For example, machining substrate 320 can remove material from the substrate (e.g., from an upper or first surface of the substrate) to form features (e.g., protrusion 106 and/or annular recess 114) in the substrate as described herein.

In some embodiments, cutting tool 300 is positioned such that a rotational axis 302 of the cutting tool is longitudinally aligned with an intended protrusion position on substrate 320. Additionally, or alternatively, rotational axis 302 of cutting tool 300 can be substantially perpendicular to substrate 320 (e.g., a plane defined by the substrate and/or a surface of the substrate to be machined). In some embodiments, the intended protrusion position is the lateral position on substrate 320 at which protrusion 106 is intended to be formed (e.g., the lateral position on the substrate at which an axis of symmetry of the protrusion is to be located). The lateral position can be an X-Y position (e.g., along an X-axis perpendicular to a longitudinal or Z-axis, which can be parallel to rotational axis 302, and along a Y-axis perpendicular to each of the X-axis and the Z-axis). For example, the X-Y position can be a position within the X-Y plane defined by substrate 320.

In some embodiments, protrusion 106 is formed in substrate 320 by engaging the substrate with cutting tool 300 at step 204 as shown in FIG. 5. For example, cutting tool 300 is translated in a first longitudinal direction 304 toward the substrate to engage the substrate with the cutting tool while rotating the cutting tool about rotational axis 302 as shown in FIG. 6. In some embodiments, such longitudinal translation of cutting tool 300 is performed without translating the cutting tool in a lateral direction (e.g., a direction oblique to rotational axis 302, such as the X-direction or the Y-direction). In some embodiments, cutting tool 300 is disengaged from substrate 320 at step 206 as shown in FIG. 5 (e.g., after forming protrusion 106 and/or annular recess 114 in the substrate). For example, cutting tool 300 is translated in a second longitudinal direction 306 away from substrate 320 to disengage the cutting tool from the substrate. In some embodiments, such longitudinal translation of cutting tool 300 is performed without translating the cutting tool in a lateral direction.

Limiting translation of cutting tool 300 to the longitudinal directions (e.g., toward and away from substrate 320) during the engaging and disengaging the cutting tool with the substrate, without translation in the lateral directions, can help to enable forming protrusion 106 with a smooth and/or straight surface as described herein. Additionally, or alternatively, limiting translation of cutting tool 300 to the longitudinal directions, without translation in the lateral directions, can help to reduce or eliminate circular features and/or facets that can be formed on a machined surface using conventional machining techniques in which a machining tool is simultaneously rotated and translated laterally. For example, circular features can include visible and/or measurable circular indentations present on a machined surface (e.g., a machined protrusion, which can have a cylindrical or frustoconical surface) that result from a non-perfect cutting or grinding operation. Such circular features can be about 20 nm to about 2 μm deep (Ra) and/or extend about 5° or about 10° to about 360° along a perimeter (e.g., a circumference) of the machined surface. Additionally, or alternatively, facets can include adjacent planar surface segments present on a machined surface (e.g., a machined protrusion, which can have a cylindrical or frustoconical surface) that can result from approximation of the intended surface shape (e.g., by X-Y circular interpolation of a computer numerical control (CNC) machine). Additionally, or alternatively, facets can result from vibration of a cutting tool (e.g., a turning tool) during machining. The machined surface of protrusion 106 formed as described herein can be a random textured surface. For example, the random textured surface can be a surface with high frequency or short term topography comprising or consisting essentially of non-repeating or coherent microfeatures, which can be indicative of machining. A random textured surface can have the relatively low surface roughness described herein. The random textured surface can be characterized, for example, using a 3D optical microscope. Additionally, or alternatively, the random textured surface can be characterized, for example, as described in ISO and/or ASME roughness computations according to ISO 4287 or ISO 4288 (e.g., for 2D roughness applications) and/or ISO 25178 (e.g., for 3D applications).

The process described above can be repeated to form additional protrusions 106 (e.g., the plurality of protrusions of mold 102). In some embodiments, cutting tool 300 is repositioned at step 208 as shown in FIG. 5. For example, cutting tool 300 is translated in the lateral direction to position (e.g., reposition) the cutting tool adjacent substrate 320. In some embodiments, cutting tool 300 is positioned such that rotational axis 302 of the cutting tool is longitudinally aligned with a second intended protrusion position on substrate 320. In some embodiments, cutting tool 300 is laterally translated while the cutting tool is disengaged from substrate 320 (e.g., to avoid forming circular features and/or facets in the substrate).

In some embodiments, a second protrusion 106 is formed in substrate 320 by engaging the substrate with cutting tool 300 at step 210 as shown in FIG. 5. For example, cutting tool 300 is translated in first longitudinal direction 306 toward substrate 320 to engage the substrate with the cutting tool while rotating the cutting tool about rotational axis 302. In some embodiments, such longitudinal translation of cutting tool 300 is performed without translating the cutting tool in the lateral direction.

In some embodiments, cutting tool 300 is disengaged from substrate 320 at step 212 as shown in FIG. 5. For example, cutting tool 300 is translated in second longitudinal direction 306 away from substrate 320. In some embodiments, such longitudinal translation of cutting tool 300 is performed without translating the cutting tool in the lateral direction.

FIG. 7 is a perspective view of some embodiments of cutting tool 300, and FIG. 8 is a cross-sectional projection of the cutting tool during rotation of the cutting tool about rotational axis 302. In some embodiments, cutting tool 300 comprises a cutting edge 308. In some of such embodiments, upon rotating cutting tool 300 about rotational axis 302, a negative space 310 is defined by the cutting edge 308. For example, negative space 310 is a void defined within cutting edge 308 as cutting tool 300 rotates about rotational axis 302 (e.g., as the cutting edge revolves in a complete revolution about the rotational axis). Thus, negative space 310 can be rotationally symmetrical about rotational axis 302.

Although cutting tool 300 described in reference to FIGS. 7-8 comprises a single cutting edge 308, other embodiments are included in this disclosure. For example, in some embodiments, the cutting tool comprises two cutting edges. For example, the two cutting edges are disposed opposite each other such that the cross-section of the cutting tool resembles the projection shown in FIG. 8, with the negative space defined between the cutting edges. In some embodiments, the cutting tool can have three, four, or more cutting edges. The cutting tool with a plurality of cutting edges can be balanced during rotation, which can reduce vibration and/or can have increased cutting capacity compared to the cutting tool comprising a single cutting edge.

In some embodiments, negative space 310 has a shape that corresponds to a shape of protrusion 106. For example, in the embodiments shown in FIGS. 7-8, negative space 310 has a substantially conical or frustoconical shape. In some embodiments, cutting edge 308 removes substrate material from substrate 320 as cutting tool 300 is engaged with the substrate while rotating about rotational axis 302. For example, forming protrusion 106 comprises engaging substrate 320 with cutting tool 300 to shave substrate material (e.g., graphite material) from the substrate. In some embodiments, such shaving of substrate material from substrate 320 is performed without shearing the substrate material. For example, shaving can comprise cutting the substrate material (e.g., cutting individual grains of the substrate material), which can help to enable the machined surface of the substrate having a high quality surface with a shape that more nearly matches the intended shape. In contrast, shearing can comprise eroding or removing grains of the substrate material from the bulk of the substrate, which can result in the machined surface of the substrate having poor surface quality (e.g., with pits or other irregularities).

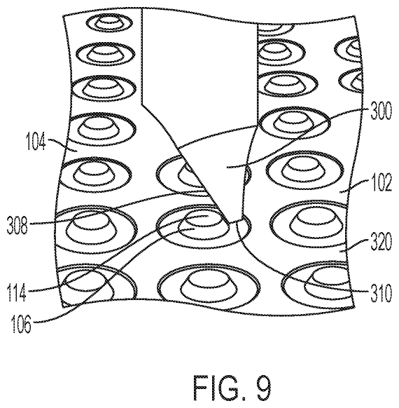

In some embodiments, cutting tool 300 comprises a cutting tip 312 disposed at a distal end of the cutting tool. For example, cutting tip 312 comprises a flattened or rounded tip defining an end of cutting tool 300. FIG. 9 is a perspective view of some embodiments of cutting tool 300 engaged with substrate 320 to form protrusion 106 and annular recess 114 in the substrate. In some embodiments, forming protrusion 106 comprises engaging substrate 320 with cutting tip 312 of cutting tool 300 to form annular recess 114 surrounding the protrusion. For example, cutting tool 300 is engaged with substrate 320 as the cutting tool rotates about rotational axis 302 such that cutting edge 308 forms the engaging surface of protrusion 106 as cutting tip 312 forms annular recess 114.

Rotation of cutting edge 308 about rotational axis 302 to form negative space 310 corresponding to the shape of protrusion 106 can enable the cutting tool to be engaged with substrate 320 to form the protrusion in the substrate with longitudinal translation of the cutting tool (e.g., without lateral translation of the cutting tool). Cutting tool 300 described herein can enable protrusion 106 having the smooth and/or straight surface described herein, thereby enabling a shaped article having a cavity with smooth and/or straight sidewalls also as described herein. For example, conventional machining techniques in which a turning tool is translated along three axes can attempt to form a curved surface using a plurality of short linear segments, thereby forming a plurality of facets that approximate the curved surface. In contrast, cutting tool 300 described herein can enable the curved surface (e.g., the engaging surface of protrusion 106) to be formed by rotating cutting edge 308 without the lateral translation that would form a plurality of facets about the curved surface.

In some embodiments, cutting edge 308 is substantially linear. Linearity can be determined, for example, by dividing the cutting edge into five sample segments, determining the highest and lowest points in each sample segment, and calculating the difference between the average highest point and the average lowest point. For example, cutting edge 308 comprises a linearity of about 0.5 μm, about 0.4 μm, about 0.3 μm, about 0.2 μm, or any ranges defined by the listed values. In some embodiments, such linearity can be enabled at least in part by the relatively small grain size of the graphite material used for the substrate as described herein.

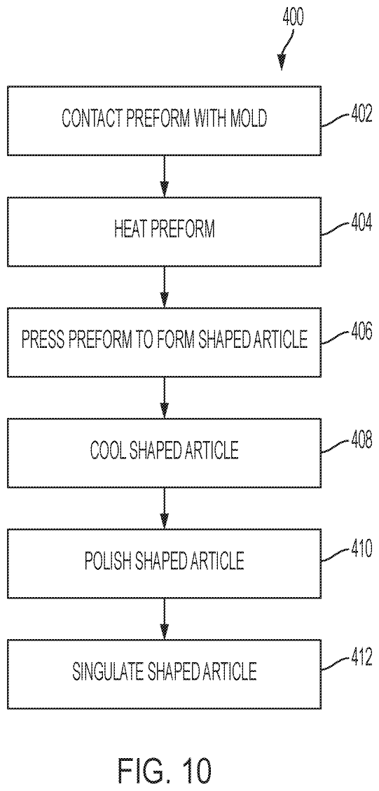

FIG. 10 is a flowchart representing some embodiments of a method 400 for forming a shaped article. In some embodiments, method 400 comprises contacting a preform with a mold at step 402.

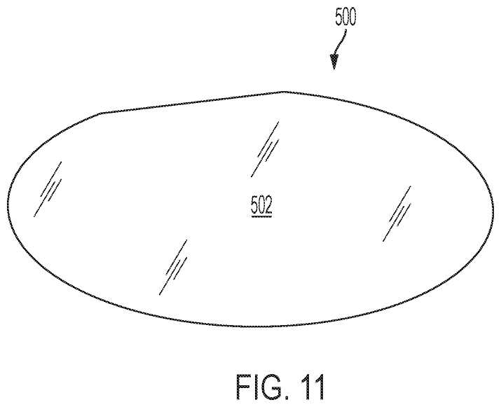

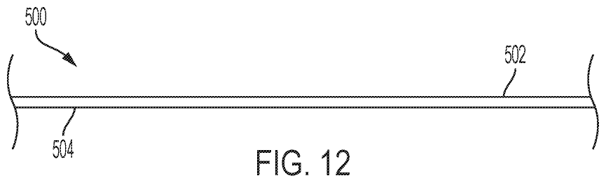

FIG. 11 is a perspective view of some embodiments of a preform 500, and FIG. 12 is a cross-sectional view of the preform. In some embodiments, preform 500 is configured as a wafer, a sheet, or a plate. For example, preform 500 comprises a first surface 502 and a second surface 504 substantially parallel to the first surface. A thickness of preform 500 is a distance between first surface 502 and second surface 504. In some embodiments, preform 500 has a circular circumferential or perimetrical shape as shown in FIG. 11. In other embodiments, the preform can have a triangular, rectangular, elliptical, or other polygonal or non-polygonal circumferential or perimetrical shape. For example, the preform 500 can be a wafer having a substantially circular circumferential shape and with or without a reference flat disposed on an outer circumference or perimeter of the preform. In some embodiments, first surface 502 of preform 500 (e.g., the surface of the preform engaged by mold 102 as described herein) has a surface area of about 100 cm², about 200 cm², about 300 cm², about 400 cm², about 500 cm², about 600 cm², about 700 cm², about 800 cm², about 900 cm², about 1000 cm², about 1100 cm², about 1200 cm², about 1300 cm², about 1400 cm², about 1500 cm², or any ranges defined by the listed values. For example, preform 500 can be a 6 inch wafer with a surface area of about 121.55 cm², an A6 plate with a surface area of about 155.4 cm², an 8 inch wafer with a surface area of about 162.15 cm², an A5 plate with a surface area of about 310.8 cm², an A4 plate with a surface area of about 623.7 cm², an A3 plate with a surface area of about 1247.4 cm², or another suitably sized preform with a suitable surface area. Such a large surface area can be enabled by mold 100 described herein (e.g., by enabling increased pressing temperature and/or reduced pressing pressure). In some embodiments, preform 500 is formed from a glass material, a glass-ceramic material, or a combination thereof. For example, preform 500 is a glass wafer.

In some embodiments, the contacting comprises contacting preform 500 with mold 102 described herein. For example, the contacting comprises bringing at least a portion of the mold surface (e.g., mold protrusions 106) into contact with first surface 502 of preform 500.

In some embodiments, method 400 comprises heating the preform at step 404 as shown in FIG. 10. For example, heating preform 500 comprises heating the preform in a heating device such as an oven or a lehr. Thus, the heating can be performed as a batch process (e.g., in a static oven) or a continuous process (e.g., in a dynamic lehr). In some embodiments, the heating comprises heating preform 500 to a pressing temperature. The pressing temperature can be a temperature sufficient to cause preform 500 to soften to a desired viscosity for pressing as described herein. For example, the pressing temperature is a temperature at which preform 500 has a viscosity of about 10⁵ poise, about 10⁶ poise, about 10⁷ poise, about 10⁸ poise, about 10^{8.5} poise, about 10⁹ poise, about 10¹⁰ poise, about 10¹¹ poise, about 10¹² poise, or any ranges defined by the listed values. In some embodiments, the heating comprises ramping the temperature of preform 500 to the pressing temperature (e.g., from room temperature (e.g., about 20° C.) to the pressing temperature) over a ramp period. For example, the ramp period is about 0.5 hours, about 1 hour, about 1.5 hours, about 2 hours, about 2.5 hours, or any ranges defined by the listed values. Gradually heating the preform over the ramp period can help to avoid thermally shocking the preform.

The heating can be performed before and/or after the contacting. For example, in some embodiments, preform 500 is contacted with mold 102, and then the preform and the mold are heated together to bring the preform to the pressing temperature. In other embodiments, preform 500 is heated to an intermediate temperature (e.g., a temperature between room temperature and the pressing temperature) prior to being contacted with mold 102, and then the preform and the mold are further heated to bring the preform to the pressing temperature.

In some embodiments, method 400 comprises pressing the preform with the mold at a pressing temperature and a pressing pressure sufficient to transform the preform into a shaped article comprising a plurality of cavities corresponding to the plurality of mold protrusions at step 406 as shown in FIG. 10. For example, the pressing comprises applying a sufficient force on mold 102 to press mold protrusions 106 into first surface 502 of preform 500, thereby forming the cavities in the preform and transforming the preform into the shaped article. For example, the pressing pressure can be about 0.1 N/cm² to about 10 N/cm². The pressing pressure can depend on the pressing temperature. For example, a higher pressing pressure may be used in combination with a lower pressing temperature (e.g., to compensate for the higher viscosity of the preform). Conversely, a lower pressing pressure may be used in combination with a higher pressing temperature (e.g., to compensate for the lower viscosity of the preform).

In some embodiments, mold 102 is formed from the porous material as described herein. Such a configuration of mold 102 can enable an isothermal pressing process for producing shaped articles with high precision and/or high registration. For example, the porous material of mold 102 can help to prevent gas entrapment during pressing and/or enable venting during mold release, or demolding.

In some embodiments, pressing the preform comprises pressing the preform between the mold and a backing plate. For example, the pressing comprises pressing preform 500 between mold 102 and backing plate 120. In some embodiments, the pressing comprises maintaining preform 500 at the pressing temperature and/or maintaining the pressing force on mold 102 for a dwell time sufficient to transform the preform into the shaped article. For example, the dwell time is about 1 minute, about 5 minutes, about 10 minutes, about 20 minutes, about 30 minutes, or any ranges defined by the listed values.

FIG. 4 schematically illustrates some embodiments of mold 102 and preform 500 during the pressing. In some embodiments, during the pressing, mold protrusions 106 are pressed into preform 500 as shown in FIG. 4. Such engagement and/or squeezing of preform 500 between mold 102 and backing plate 120 can cause material of the preform to flow into annular recesses 114 of mold body 104 and/or depressions 122 of backing plate 120.

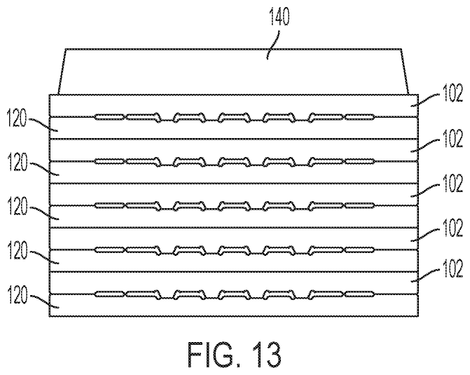

FIG. 13 is a cross-sectional schematic view of some embodiments of the pressing. In some embodiments, apparatus 100 comprises a plurality of molds 102 and a plurality of backing plates 120 as shown in FIG. 13. Molds 102 and backing plates 120 can be arranged in an alternating stacked arrangement as shown in FIG. 13. The pressing force can be applied to the stack of molds 102 and backing plates 120. For example, the pressing force is applied by placing a weight 140 on top of the stack. Additionally, or alternatively, the pressing force is applied using a mechanical press, or another suitable pressing device. Using a plurality of molds and backing plates can enable an increase in the rate of manufacturing shaped articles.

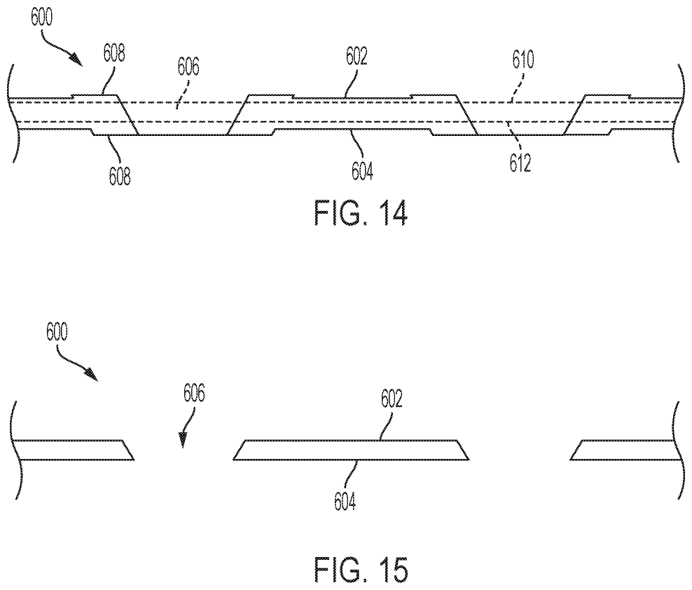

FIG. 14 is a partial cross-sectional schematic view of some embodiments of a shaped article 600 following the pressing. Shaped article 600 comprises a first surface 602 corresponding to first surface 502 of preform 500 and a second surface 604 opposite the first surface and corresponding to second surface 504 of the preform. In some embodiments, shaped article 600 comprises a plurality of cavities 606 formed in first surface 602 and corresponding to the plurality of mold protrusions 106 of mold 102. In some embodiments, cavities 606 are blind holes that do not extend entirely through shaped article 600 as shown in FIG. 14. Thus, cavities 606 comprise an open end at first surface 602 of shaped article 600 and a closed end near second surface 604 of the shaped article. In other embodiments, the cavities are through-holes extending entirely through the shaped article. Cavities 606 can have a size and shape corresponding to mold protrusions 106. For example, cavities 606 can have a diameter or width of about 5 mm, about 4 mm, about 3 mm, about 2 mm, about 1 mm, about 0.5 mm, or any ranges defined by the listed values. The diameter or width of cavities 606 can refer to the diameter or width at first surface 602 of shaped article 600 and/or second surface 604 of the shaped article. Such small cavities with smooth and/or straight sidewalls can be enabled by the methods and apparatus described herein.

In some embodiments, a number of cavities 606 in the plurality of cavities corresponds to the number of mold protrusions 106 of mold 102 as described herein. For example, the number of cavities 606 in the plurality of cavities can be about 100, about 200, about 300, about 400, about 500, about 600, about 700, about 800, about 900, about 1000, about 1100, about 1200, about 1300, about 1400, about 1500, or any ranges defined by the listed values.

In some embodiments, method 400 comprises cooling the shaped article at step 408 as shown in FIG. 10. For example, cooling shaped article 600 comprises cooling the shaped article in the heating device such as the oven or the lehr. Thus, the cooling can be performed as a batch process (e.g., in a static oven) or a continuous process (e.g., in a dynamic lehr). In some embodiments, the cooling comprises cooling shaped article 600 to room temperature. In some embodiments, the cooling comprises ramping the temperature of shaped article 600 (e.g., from the pressing temperature to room temperature) over a ramp period. For example, the ramp period is about 0.5 hours, about 1 hour, about 1.5 hours, about 2 hours, about 2.5 hours, about 3 hours, about 4 hours, about 5 hours, or any ranges defined by the listed values. Gradually cooling the shaped article over the ramp period can help to avoid thermally shocking the shaped article.

In some embodiments, following the pressing and/or the cooling, shaped article 600 comprises one or more raised portions 608 disposed on one or more surfaces of the shaped article as shown in FIG. 14. For example, first surface 602 of shaped article 600 comprises raised portions 608 corresponding to annular recesses 114 of mold body 104. Such raised portions 608 can result from flow of material of preform 500 into annular recesses 114 during the pressing. Additionally, or alternatively, second surface 604 of shaped article 600 comprises raised portions 608 corresponding to depressions 122 of backing plate 120. Such raised portions 608 can result from flow of material of preform 500 into depressions 122 during the pressing. Thus, in various embodiments, first surface 602 and/or second surface 604 are non-planar following pressing.

In some embodiments, method 400 comprises polishing the shaped article at step 410 as shown in FIG. 10. For example, polishing shaped article 600 comprises polishing at least one of first surface 602 of the shaped article or second surface 604 of the shaped article following the pressing and/or the cooling.

FIG. 15 is a cross-sectional schematic view of some embodiments of shaped article 600 following the polishing. In some embodiments, the polishing comprises removing material from first surface 602 of shaped article 600. For example, the polishing comprises removing material from first surface 602 down to dashed line 610 shown in FIG. 14. Such polishing can remove raised portions 608 on first surface 602, resulting in a substantially planar surface, excluding cavities 606, as shown in FIG. 15. In some embodiments, the polishing comprises removing material from second surface 604 of shaped article 600. For example, the polishing comprises removing material from second surface 604 down to dashed line 612 shown in FIG. 14. Such polishing can remove raised portions 608 on second surface 604, resulting in a substantially planar surface, excluding cavities 606, as shown in FIG. 15. The polishing can be achieved by mechanical grinding, chemical etching, thermal treatment, or another suitable polishing process. Mechanical grinding can be beneficial in enabling removal of material from the surfaces of the shaped article without altering the sidewalls of the cavities, which can help to preserve the surface quality of the sidewalls as described herein.

In some embodiments, after the pressing and prior to the polishing, cavities 606 of shaped article 600 comprise blind holes as shown in FIG. 14 and described herein. In some of such embodiments, the polishing opens the blind holes to transform the plurality of cavities 606 into a plurality of through-holes as shown in FIG. 15. For example, the polishing removes the closed end of the blind holes to open the blind holes and form the through-holes.

In some embodiments, the polishing does not affect the surfaces of the sidewalls of cavities 606. Thus, before and after the polishing, the sidewalls are unpolished sidewalls. In some embodiments, the sidewalls of cavities 606 of shaped article 600 have an unpolished or as-pressed surface roughness (e.g., following the pressing, the cooling, and/or the polishing) of about 120 nm, about 110 nm, about 100 nm, about 90 nm, about 80 nm, about 70 nm, about 60 nm, about 50 nm, about 40 nm, about 30 nm, about 20 nm, about 10 nm, about 5 nm, or any ranges defined by the listed values. Such a smooth surface can be enabled by the smoothness of mold protrusion 106, which can be enabled by the machining process used to form mold 102 as described herein. In some embodiments, the sidewalls of cavities 606 of shaped article 600 are substantially straight. For example, the deviation of the sidewalls of cavities 606 from linear is within +/−0.25 μm along the sidewall through a thickness of shaped article 600. In some embodiments, cavities 606 have a truncated conical shape with smooth and substantially straight sidewalls. In some embodiments, the sidewalls of cavities 606 of shaped article 600 have a random textured surface (e.g., corresponding to the random textured surface of protrusions 106 of mold 102 as described herein).

In some embodiments, a thickness of shaped article 600 (e.g., a distance between first surface 602 and second surface 604), before or after polishing, can be about 5 mm, about 4 mm, about 3 mm, about 2 mm, about 1 mm, about 0.9 mm, about 0.8 mm, about 0.7 mm, about 0.6 mm, about 0.5 mm, about 0.4 mm, about 0.3 mm, about 0.2 mm, about 0.1 mm, or any ranges defined by the listed values.

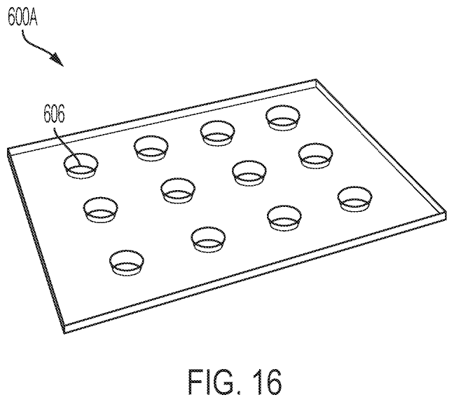

In some embodiments, method 400 comprises singulating the shaped article at step 412 as shown in FIG. 10. For example, singulating shaped article 600 comprises separating the shaped article into two or more shaped sub-articles following the pressing, the cooling, and/or the polishing. In some embodiments, shaped article 600 comprises one or more cutting paths formed therein. For example, the cutting paths are thinned regions of shaped article 600 formed by ribs 130 of mold 102 and/or backing plate 120. In some of such embodiments, singulating shaped article 600 comprises cutting or breaking the shaped article along the cutting paths. For example, FIG. 16 is a perspective view of some embodiments of a shaped sub-article 600A formed by breaking shaped article 600 along a plurality of cutting paths. In some embodiments, singulating shaped article 600 comprises dicing the shaped article (e.g., with a mechanical dicing saw, a laser, or another suitable cutting device). For example, the singulating comprises dicing shaped article 600 to form a plurality of shaped sub-articles, and each sub-article comprises a single cavity 606. Such shaped sub-articles can be used to form liquid lenses as described herein.

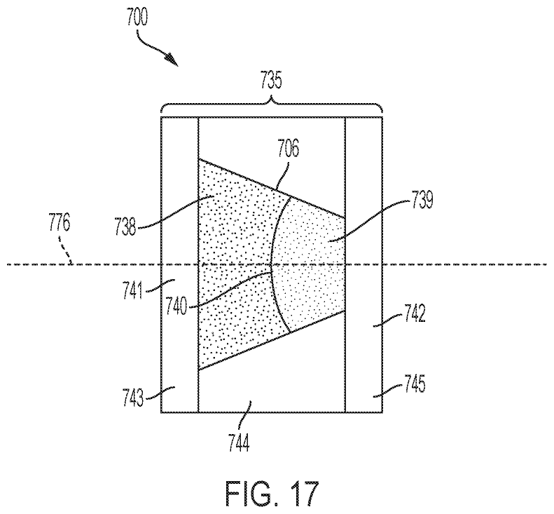

In some embodiments, the methods and apparatus described herein can be used to manufacture liquid lenses. FIG. 17 is a cross-sectional schematic view of some embodiments of a liquid lens 700 incorporating shaped article 600. In some embodiments, liquid lens 700 comprises a lens body 735 and a cavity 706 formed in the lens body. A first liquid 738 and a second liquid 739 are disposed within cavity 706. In some embodiments, first liquid 738 is a polar liquid or a conducting liquid. Additionally, or alternatively, second liquid 739 is a non-polar liquid or an insulating liquid. In some embodiments, first liquid 738 and second liquid 739 are immiscible with each other and have different refractive indices such that an interface 740 between the first liquid and the second liquid forms a lens. Interface 740 can be adjusted via electrowetting. For example, a voltage can be applied between first liquid 738 and a surface of cavity 706 (e.g., an electrode positioned near the surface of the cavity and insulated from the first liquid) to increase or decrease the wettability of the surface of the cavity with respect to the first liquid and change the shape of interface 740. In some embodiments, adjusting interface 740 changes the shape of the interface, which changes the focal length or focus of liquid lens 700. For example, such a change of focal length can enable liquid lens 700 to perform an autofocus (AF) function. Additionally, or alternatively, adjusting interface 740 tilts the interface relative to an optical axis 776. For example, such tilting can enable liquid lens 700 to perform an optical image stabilization (01S) function. Such adjustment of interface 740 via electrowetting can be sensitive to surface roughness and/or non-linearity of the sidewalls of cavity 706. Thus, the methods and apparatus described herein for forming shaped article 600 having cavities 606 with smooth and/or substantially straight sidewalls may be beneficial for forming cavity 706 for liquid lens 700. In some embodiments, first liquid 738 and second liquid 739 have substantially the same density, which can help to avoid changes in the shape of interface 740 as a result of changing the physical orientation of liquid lens 700 (e.g., as a result of gravitational forces).

In some embodiments, lens body 735 of liquid lens 700 comprises a first window 741 and a second window 742. In some of such embodiments, cavity 706 is disposed between first window 741 and second window 742. In some embodiments, lens body 735 comprises a plurality of layers that cooperatively form the lens body. For example, in the embodiments shown in FIG. 17, lens body 735 comprises a cap 743, a shaped plate 744, and a base 745. In some embodiments, shaped plate 744 with cavity 706 comprises or is formed from shaped article 600 with cavity 606. For example, shaped plate 744 with cavity 706 is formed as described herein with reference to shaped article 600 with cavity 606, cap 743 is bonded to one side (e.g., an object side) of the shaped plate, and base 745 is bonded to the other side (e.g., an image side) of the shaped plate such that the cavity is covered on opposing sides by the cap and the base. Thus, a portion of cap 743 covering cavity 706 serves as first window 741, and a portion of base 745 covering the cavity serves as second window 742. In other embodiments, the cavity is a blind hole that does not extend entirely though the shaped plate. In such embodiments, the base can be omitted, and the closed end of the cavity can serve as the second window.

In some embodiments, cavity 706 has a truncated conical shape as shown in FIG. 17 such that a cross-sectional area of the cavity decreases along optical axis 776 in a direction from the object side to the image side. Such a tapered cavity can help to maintain alignment of interface 740 between first liquid 738 and second liquid 739 along optical axis 776. In other embodiments, the cavity is tapered such that the cross-sectional area of the cavity increases along the optical axis in the direction from the object side to the image side or non-tapered such that the cross-sectional area of the cavity remains substantially constant along the optical axis.

In some embodiments, image light enters liquid lens 700 through first window 741, is refracted at interface 740 between first liquid 738 and second liquid 739, and exits the liquid lens through second window 742. In some embodiments, cap 743 and/or base 745 comprise a sufficient transparency to enable passage of image light. For example, cap 743 and/or base 745 comprise a polymeric material, a glass material, a ceramic material, a glass-ceramic material, or a combination thereof. In some embodiments, outer surfaces of cap 743 and/or base 745 are substantially planar. Thus, even though liquid lens 700 can function as a lens (e.g., by refracting image light passing through interface 740), outer surfaces of the liquid lens can be flat as opposed to being curved like the outer surfaces of a fixed lens. In other embodiments, outer surfaces of the cap and/or the base are curved. Thus, the liquid lens comprises an integrated fixed lens. In some embodiments, shaped plate 744 comprises a glass material, a glass-ceramic material, or a combination thereof as described herein. Because image light can pass through the cavity through shaped plate 744, the shaped plate may or may not be transparent.

Although FIG. 17 illustrates a single liquid lens 700, liquid lenses can be manufactured in arrays using a wafer manufacturing process as described herein. For example, a liquid lens array comprises a plurality of liquid lenses 700 attached in a plate or wafer. Thus, prior to singulation to form single liquid lens 700, shaped plate 744 comprises a plurality of cavities 706. Additionally, or alternatively, prior to singulation, cap 743 comprises a plate with a plurality of first windows 741 corresponding to the plurality of cavities 706. Additionally, or alternatively, prior to singulation, base 745 comprises a plate with a plurality of second windows 742 corresponding to the plurality of cavities 706. After formation, the liquid lens array can be singulated to form the individual liquid lenses 700.

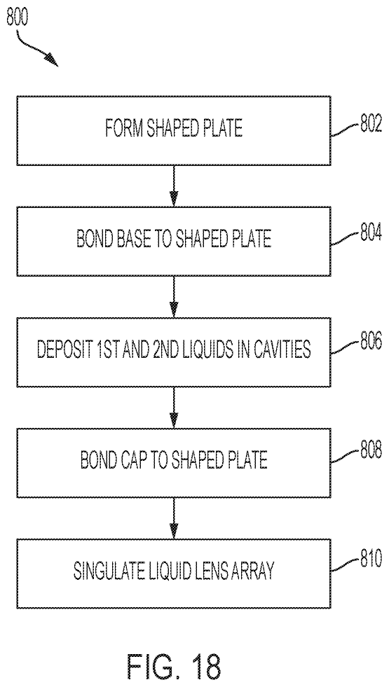

FIG. 18 is a flowchart representing some embodiments of a method 800 for manufacturing a liquid lens. In some embodiments, method 800 comprises forming a shaped plate comprising a plurality of cavities. For example, method 800 comprises forming shaped plate 744 comprising the plurality of cavities 706 at step 802 (e.g., as described herein with reference to forming shaped article 600 comprising the plurality of cavities 606).

In some embodiments, method 800 comprises bonding a base to a surface of the shaped plate. For example, method 800 comprises bonding base 745 to shaped plate 744 at step 804. The bonding comprises, for example, laser bonding, adhesive bonding, or another suitable bonding technique.

In some embodiments, method 800 comprises depositing first and second liquids into the plurality of cavities of the shaped plate. For example, method 800 comprises depositing first liquid 738 and second liquid 739 in each of the plurality of cavities 706 of shaped plate 744 at step 806.

In some embodiments, method 800 comprises bonding a cap to a surface of the shaped plate to seal the first liquid and the second liquid within the plurality of cavities and form a liquid lens array. For example, method 800 comprises bonding cap 743 to shaped plate 744 to seal first liquid 738 and second liquid 739 within the plurality of cavities 706 of the shaped plate 808. The bonding comprises, for example, laser bonding, adhesive bonding, or another suitable bonding technique.

In some embodiments, method 800 comprises singulating the liquid lens array to form a plurality of individual liquid lenses. For example, method 800 comprises singulating the liquid lens array comprising cap 743, shaped plate 744, and optionally, base 745 to form the plurality of individual liquid lenses 700 at step 810. The singulating comprises, for example, mechanical dicing, laser dicing, or another suitable dicing technique.

The methods and apparatus described herein for forming shaped articles with a plurality of cavities formed therein can enable large-scale production of shaped plates having cavities with sufficiently smooth surfaces to be used in electrowetting applications, which in turn, can enable efficient manufacturing of liquid lens arrays and/or singulated liquid lenses.

Although FIG. 18 illustrates using the methods and apparatus described herein to manufacture liquid lenses, other embodiments are included in this disclosure. For example, in other embodiments, the methods and apparatus described herein can be used to make shaped articles for use in optics, biological, microfluidic, or any other suitable applications.

In some embodiments, a shaped article comprises a plate comprising a glass material, a glass-ceramic material, or a combination thereof and a plurality of cavities formed in the plate. In some of such embodiments, an unpolished sidewall of each of the plurality of cavities has a surface roughness of less than or equal to 120 nm. Additionally, or alternatively, the plate comprises a first surface and a second surface opposite the first surface, and the first surface of the plate has an area of at least about 100 cm². Additionally, or alternatively, each of the plurality of cavities has a truncated conical shape. Additionally, or alternatively, the sidewall of each of the plurality of cavities is substantially straight.

It will be apparent to those skilled in the art that various modifications and variations can be made without departing from the spirit or scope of the claimed subject matter. Accordingly, the claimed subject matter is not to be restricted except in light of the attached claims and their equivalents.

1. A method of making the apparatus of claim 27, the method comprising:
positioning a cutting tool adjacent a graphite block such that a rotational axis of the cutting tool is longitudinally aligned with an intended mold protrusion position on the graphite block;
forming the mold protrusion in the graphite block by translating the cutting tool in a first longitudinal direction toward the graphite block to engage the graphite block with the cutting tool while rotating the cutting tool about the rotational axis and without translating the cutting tool in a lateral direction; and
translating the cutting tool in a second longitudinal direction away from the graphite block and without translating the cutting tool in the lateral direction to disengage the cutting tool from the graphite block.

2. The method of claim 1, wherein:
the cutting tool comprises a cutting edge; and
upon rotating the cutting tool about the rotational axis, a negative space defined by the cutting edge corresponds to a shape of the mold protrusion.

3. (canceled)

4. (canceled)

5. (canceled)

6. (canceled)

7. (canceled)

8. (canceled)

9. (canceled)

10. (canceled)

11. The method of claim 1, wherein the graphite block comprises a graphite material with a grain size of less than or equal to about 5 μm.

12. The method of claim 1, wherein the graphite block comprises a graphite material with a porosity of greater than 0% and less than or equal to about 2%.

13. (canceled)

14. (canceled)

15. A shaped article comprising:
a substrate comprising a glass material, a glass-ceramic material, or a combination thereof; and
a cavity formed in the substrate;
wherein a sidewall of the cavity comprises a random textured surface with a surface roughness of less than or equal to 300 nm.

16. The shaped article of claim 15, wherein the sidewall of the cavity is substantially free of circular features and facets.

17. A method comprising:
pressing a preform with a monolithic graphite mold comprising a mold body and a plurality of mold protrusions extending from the mold body at a pressing temperature and a pressing pressure sufficient to transform the preform into a shaped article comprising a plurality of cavities corresponding to the plurality of mold protrusions;
wherein the preform comprises a glass material, a glass-ceramic material, or a combination thereof; and
wherein the mold protrusions of the monolithic graphite mold comprise a random textured surface.

18. The method of claim 17, wherein the random textured surface of the mold protrusions is substantially free of circular features and facets.

19. The method of claim 17, wherein the monolithic graphite mold comprises a graphite material with a grain size of less than or equal to about 5 μm.

20. The method of claim 17, wherein the monolithic graphite mold comprises a graphite material with a porosity of greater than 0% and less than or equal to about 2%.

21. The method of claim 17, wherein the monolithic graphite mold comprises a graphite material with a coefficient of thermal expansion (CTE) that is less than a CTE of the glass material, the glass-ceramic material, or the combination thereof of the preform, wherein a difference between the CTE of the graphite material and the CTE of the glass material, the glass-ceramic material, or the combination thereof of the preform is 1×10⁻⁷/° C. to 5×10⁻⁷/° C.

22. The method of claim 17, wherein sidewalls of the plurality of cavities of the shaped article have a surface roughness of less than or equal to 120 nm after the pressing and without subsequent polishing.

23. The method of claim 17, comprising polishing at least one of a first surface or a second surface of the shaped article following the pressing, wherein prior to the polishing, the plurality of cavities are blind holes, and the polishing opens the blind holes to form a plurality of through holes.

24. The method of claim 17, wherein the pressing temperature is a temperature at which the preform has a viscosity of about 10⁷ poise to about 10⁹ poise.

25. The method of claim 17, wherein the pressing pressure is about 0.1 N/cm² to about 10 N/cm².

26. The method of claim 17, wherein the preform is a plate, and a surface of the plate engaged by the mold has an area of at least about 100 cm².

27. An apparatus for pressing a plurality of cavities in a preform, the apparatus comprising:
a monolithic graphite mold comprising a mold body and a plurality of mold protrusions extending from the mold body;
wherein the mold protrusions of the monolithic graphite mold comprise a random textured surface.

28. The apparatus of claim 27, wherein the mold body comprises an annular recess surrounding each of the plurality of mold protrusions.

29. The apparatus of claim 27, wherein engaging regions of the plurality of mold protrusions have a surface roughness of less than or equal to 120 nm.

30. A liquid lens comprising:
a lens body comprising the shaped article of claim 15, a first window, and a second window, the cavity of the shaped article disposed between the first window and the second window; and
a first liquid and a second liquid disposed within the cavity, the first liquid and the second liquid having different refractive indices such that an interface between the first liquid and the second liquid forms a lens.
